(19) United States
(12) Patent Application Publication
(10) Pub. No.: US 2026/0197852 A1
(43) Pub. Date: Jul. 9, 2026

(54) SYSTEMS AND METHODS FOR INTELLIGENT SCHEDULING FOR WIRELESS NETWORKS SERVING HIGH-MOBILITY/HIGH-USAGE USER EQUIPMENT

(71) Applicant: Verizon Patent and Licensing Inc., Basking Ridge, NJ (US)

(72) Inventors: Xin Tang, East Hanover, NJ (US); Xin Wang, Morris Plains, NJ (US); Hardik Gandhi, Parsippany, NJ (US); Lynda Ng, Castro Valley, CA (US)

(73) Assignee: Verizon Patent and Licensing Inc., Basking Ridge, NJ (US)

(21) Appl. No.: 19/015,308

(22) Filed: Jan. 9, 2025

(51) Int. Cl. H04W 72/51; H04W 8/08; H04W 28/02; H04W 36/00

(52) U.S. Cl. CPC H04W 72/51; H04W 8/08; H04W 28/0215; H04W 36/0033

(57) ABSTRACT

A system described herein may identify that a particular User Equipment (“UE”), out of a plurality of UEs associated with a wireless network, is a high-usage high-mobility (“HMHU”) UE, wherein identifying that the particular UE is a HMHU UE includes determining that the particular UE is associated with a particular set of usage characteristics, and determining that the particular UE is associated with a particular set of mobility characteristics; identify a time at which the particular UE is likely to connect to a particular base station, of a plurality of base stations of the wireless network; and indicate, to the particular base station, the time at which the particular UE is likely to connect to the particular base station, wherein the particular base station performs a set of configuration modifications to meet traffic demands of the particular UE when the particular UE connects to the particular base station.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may implement various techniques in order to attempt to meet Service Level Agreements (“SLAs”), Quality of Service (“QoS”) thresholds, etc. associated with services provided via the wireless networks, such as voice call services, data traffic services, content streaming services, IoT control services, or the like. The SLAs, QoS thresholds, etc. may include maximum latency thresholds, minimum throughput thresholds, and/or other types of thresholds.

### BRIEF DESCRIPTION OF THE DRAWINGS

FIG. 1 illustrates an example identification of a high-mobility/high-usage UE, in accordance with some embodiments;

FIG. 2 illustrates an example arrangement of a high-mobility/high-usage UE, in accordance with some embodiments;

FIG. 3 illustrates an example of scheduling and/or configuration modifications performed by a base station of some embodiments;

FIGS. 4 and 5 illustrate an example of registering a UE as a high-mobility/high-usage UE, in accordance with some embodiments;

FIG. 6 illustrates an example process for providing a high-mobility/high-usage service in a wireless network, in accordance with some embodiments;

FIGS. 7 and 8 illustrate example environments in which one or more embodiments, described herein, may be implemented;

FIG. 9 illustrates an example arrangement of a radio access network (“RAN”), in accordance with some embodiments;

FIG. 10 illustrates an example arrangement of an Open RAN (“O-RAN”) environment in which one or more embodiments, described herein, may be implemented; and

FIG. 11 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

UEs may connect to wireless networks, such as Fifth Generation (“5G”) networks, Long-Term Evolution (“LTE”) networks, or the like, in order to communicate with one or more other devices or networks. For example, a UE may communicate with one or more application servers, via a wireless network, in order to receive services provided by the application servers, such as voice call services, content streaming services, videoconferencing services, and/or other types of services.

In some implementations, a UE may be implemented by, may implement, may be communicatively coupled to, and/or may otherwise be associated with a dual-or multi-radio access technology (“RAT”) access point. The dual-or multi-RAT access point may include or may be otherwise associated with a “hotspot” or a “wireless hotspot” device that communicates with a RAN of the wireless network via a first RAT (e.g., a 5G RAT, an LTE RAT, etc.) and that implements a wireless local area network (“WLAN”) using a second RAT, such as a Wi-Fi RAT or some other suitable RAT (e.g., which may be a different RAT from the first RAT). The WLAN may provide connectivity via the second RAT to other devices, such as smart phones, tablets, IoT devices, laptops, streaming devices, etc. UEs, such as hotspots, that provide connectivity to multiple other devices may send and receive relatively large amounts of RAN traffic (e.g., consume more throughput or bandwidth via a RAN) than other UEs such as smart phones, IoT devices, tablets, personal devices, or the like. In one scenario, for example, a single smart phone may be used by a user to access one item of streaming content (e.g., one streaming movie), a hotspot may provide wireless connectivity to dozens or hundreds of smart phones which may concurrently be accessing dozens or hundreds of different streaming content items or other network-based services.

In this sense, such UEs (e.g., UEs that serve as a dual-or multi-RAT access point for other devices) may be considered as high-usage (“HU”) UEs, as such UEs send and/or receive greater amounts of traffic than typical UEs. In other scenarios, other types of UEs that send and/or receive greater amounts of traffic than typical UEs, or are otherwise associated with relatively high measures of usage, may be considered as HU UEs. For example, a wireless network may register or provision a particular UE or set of UEs as HU UEs. As another example, UEs that send and/or receive at least a threshold amount of traffic over a given time window may be identified as HU UEs. In other examples, HU UEs may be identified or designated in some other suitable manner.

Additionally, in some scenarios, HU UEs may further be high-mobility HU UEs (“HMHU UEs”). HMHU UEs may be HU UEs that are identified as being relatively highly mobile, which may be determined based on factors such as historical location information, predicted location information (e.g., using artificial intelligence/machine learning (“AI/ML”) modeling techniques or other suitable techniques), and/or other location information.

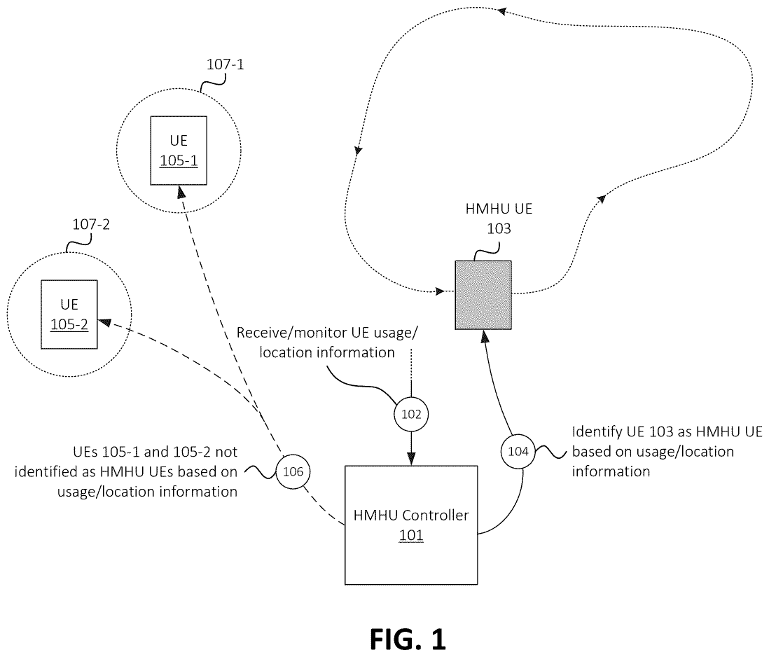

As shown in FIG. 1, for example, HMHU Controller 101 of some embodiments may receive and/or monitor usage and/or geographical location information associated with UE 103 and one or more other UEs, such as UEs 105 (e.g., UEs 105-1 and 105-2). Usage information may refer to, for example, the amount of traffic received from and/or sent to UEs 103 and/or 105 (e.g., uplink and/or downlink traffic) via one or more RANs of a wireless network. The usage information may be indicated in terms of data size (e.g., kilobytes, megabytes, gigabytes, etc.), throughput (e.g., kilobytes per second, megabytes per second, gigabytes per second, etc.), radio resource usage (e.g., symbols, data frames, Physical Resource Blocks (“PRBs”), etc.), and/or other suitable measures of network resource usage. In some embodiments, the usage information may include communication session information, such as a quantity of communication sessions associated with UEs 103 and/or 105 (e.g., a quantity of protocol data unit (“PDU”) sessions established between UEs 103/105 and a core of a wireless network).

The geographical location information for a given UE 103 or 105 may include latitude and longitude coordinates, Global Positioning System (“GPS”) coordinates, network cell or sector identifiers, Tracking Area Identifiers (“TAIs”), and/or other indications of geographical locations at which UEs 103 and 105 have been located at given times. In some embodiments, the geographical location information may include mobility information, and/or mobility information may be able to be derived from the geographical location information. As discussed below, the mobility information may include speed information, direction or heading information, the duration of time spent by a given UE at a particular location (e.g., within a cell or coverage area of a particular base station), or the like.

In some embodiments, the UE usage and/or location information may be actual information that was measured, determined, collected, etc. based on actual historical UE usage and/or based on actual historical UE location information. In some embodiments, the usage and/or location information may include predicted or modeled usage and/or location information, which may be determined using one or more models (e.g., AI/ML models) with actual or simulated historical UE usage and/or actual or simulated historical UE location information as inputs to such models.

HMHU Controller 101 may receive (at 102) the UE usage and/or location information directly from UEs 103 and/or 105 (e.g., via an application programming interface (“API”), an application, and/or some other suitable communication pathway), from a wireless network with which UEs 103 and 105 are registered or provisioned, from a wireless network to which UEs 103 and 105 are connected, and/or from some other suitable device or system that monitors or identifies such information.

For example, HMHU Controller 101 may receive such information from an Access and Mobility Management Function (“AMF”), a Mobility Management Entity (“MME”), and/or some other element of the wireless network. In some embodiments, HMHU Controller 101 may communicate with such elements of the wireless network via a Network Exposure Function (“NEF”), a Service Capability Exposure Function (“SCEF”), or some other suitable secure communication pathway via which the wireless network provides information to devices or systems external to the wireless network. In some embodiments, HMHU Controller 101 may receive or monitor UE usage and/or location information after obtaining consent from respective users of UEs 103 and/or 105 to monitor such information, in order to protect the privacy of such users.

In this example, HMHU Controller 101 may identify (at 104), based on the received UE usage and/or location information for UE 103, that UE 103 is an HMHU UE. For example, HMHU Controller 101 may identify that usage metrics, based on historical and/or predicted usage metrics, exceed one or more thresholds and/or otherwise meet characteristics that satisfy a designation of UE 103 as an HU UE. Additionally, or alternatively, HMHU Controller 101 may receive information (e.g., from a wireless network or some other suitable source) indicating that UE 103 has been designated as an HU UE.

HMHU Controller 101 may also identify that location information, such as historical location information of UE 103, indicates that UE 103 is a high-mobility (“HM”) UE. For example, HMHU Controller 101 may identify that UE 103 is historically associated with relatively high speeds or velocities. In some embodiments, the historical location information may indicate a relatively short duration of time spent within certain locations, such as cells, sectors, coverage areas of particular base stations or other RAN infrastructure, or the like. For example, a UE that is associated with a relatively low average, mean, median, etc. duration of connection to a relatively high quantity of cells, sectors, base stations, etc. may be considered as more “mobile” than UEs that remain in the same location for longer periods of time.

On the other hand, HMHU Controller 101 may identify (at 106) other UEs (e.g., UEs 105-1 and 105-2) that are not HMHU UEs based on usage and/or location information associated with UEs 105-1 and 105-2. For example, UE 105-1 may be relatively stationary or non-mobile (e.g., may generally remain within a first geographical region 107-1 for relatively long durations of time), and UE 105-2 may also be relatively stationary or non-mobile (e.g., may generally remain within a second geographical region 107-2 for relatively long durations of time). As another example, UEs 105-1 and/or 105-2 may be HM UEs that are not HU UEs (e.g., may move relatively quickly, may be associated with relatively short connection durations to different base stations 207, etc.), and are thus not HMHU UEs. As another example, HMHU Controller 101 may receive an indication (e.g., from UEs 105, from a network with which UEs 105 are registered, and/or some other source) that UEs 105 are not HMHU UEs.

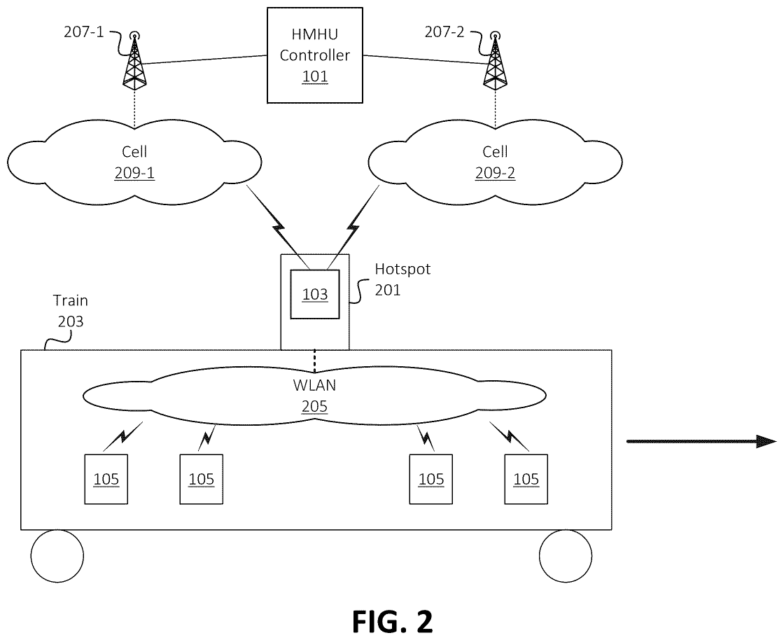

In one example, as shown in FIG. 2, UE 103 may implement, may be implemented by, may be integrated in, may be communicatively coupled to, and/or may otherwise be associated with wireless hotspot 201 that is mounted to, attached to, integrated in, etc. a vehicle, such as train 203. As shown, wireless hotspot 201 may be a dual-or multi-RAT access point that implements WLAN 205, via which UEs 105 (e.g., which are onboard train 203 as train 203 moves quickly along train tracks) may obtain wireless connectivity (e.g., to communicate with one or more other devices or networks, such as the Internet). In some embodiments, wireless circuitry of UE 103 may be used to implement WLAN 205. In some embodiments, wireless circuitry of wireless hotspot 201 (e.g., external to UE 103) may be used to implement WLAN 205.

As further shown, wireless hotspot 201 (e.g., using wireless circuitry of UE 103) may connect to a RAN of a wireless network. The RAN may include multiple base stations 207 (e.g., base station 207-1 and 207-2) that provide wireless connectivity (e.g., via an LTE RAT, a 5G RAT, or the like) to UEs such as UE 103. In this example, the coverage area of a particular base station 207 is represented as cell 209 (e.g., cell 209-1 is associated with base station 207-1, and cell 209-2 is associated with base station 207-2).

UE 103 may, in this situation, be identified (e.g., by HMHU Controller 101) as an HMHU UE based on characteristics such as relatively high throughput or other network resource consumption (e.g., based on providing or aggregating traffic to and/or from multiple UEs 105), fast travel speed, short connection durations to cells such as cells 209-1 and/or 209-2, and/or other factors. As further shown, HMHU Controller 101 may be communicatively coupled to base stations 207-1 and 207-2. As discussed below, HMHU Controller 101 may communicate with base stations 207-1 and 207-2, and/or other RAN elements, in order to facilitate resource allocations, scheduling, and/or other operations in order to accommodate the unique demands of HMHU UEs. For example, the HU aspect of UE 103 (e.g., wireless hotspot 201) may necessitate relatively large resource allocations, such as the ability to send and/or receive relatively large amounts of wireless traffic between the RAN (e.g., one or more base stations 207) and UE 103. The HM aspect of UE 103 may increase the possibility of latency being introduced in mobility situations (e.g., where train 203 travels from a location served by cell 209-1 to a location served by cell 209-2). For example, in implementations where UE 103 connects to base station 207-2 (e.g., when moving from cell 209-1 to cell 209-2), without appropriate prior preparation of base station 207-2, base station 207-2 may potentially eventually modify resource allocations or perform other configuration modifications to accommodate the high traffic demands of UE 103. Performing these configuration modifications in a reactive manner may cause disruptions to services received by UEs 105 via UE 103 (e.g., wireless hotspot 201), as base station 207-2 may potentially not initially have enough resources to accommodate the high traffic demands of UE 103. That is, the HU and HM aspects of UE 103, together, may cause unique issues that ultimately lead to a degraded user experience for users of UEs 105 that receive wireless connectivity via UE 103.

Embodiments described herein provide for a proactive resource allocation and/or scheduling mechanism for HMHU UEs, in order to preserve the performance (e.g., meet QoS thresholds or SLAs) of such HMHU UEs and/or of devices that receive connectivity via HMHU UEs. As one example, HMHU Controller 101 may determine a time that UE 103 is expected to enter cell 209-2, which may be based on a current location of UE 103 (e.g., a location of UE 103 and/or train 203, as monitored in real-time), a location history of UE 103, and/or other information (e.g., a train schedule associated with train 203, a map of train tracks on which train 203 is located, etc.). HMHU Controller 101 may further identify an amount of demand associated with UE 103 at the time at which UE 103 is expected to enter cell 209-2. The expected amount of demand may be determined using AI/ML techniques or other suitable techniques, in some embodiments. The expected amount of demand may be determined in terms of uplink and/or downlink data throughput (e.g., kilobytes per second, megabytes per second, gigabytes per second, etc.), amount of uplink and/or downlink radio resources (e.g., PRBs, symbols, etc.), quantity of PDU sessions, and/or other suitable measures of demand. In some embodiments, the amount of demand may include, or may be based on, QoS information associated with UE 103, such as performance thresholds (e.g., minimum throughput, maximum latency, etc.), SLAs, network slices, QoS indicators (e.g., QoS Class Identifier (“QCI”) values, 5G QoS Identifier (“5QI”) values, or the like) or other suitable information. In some embodiments, HMHU Controller 101 may determine an expected duration of connection to base station 207-2, such as based on a current location of UE 103, a speed of UE 103, a historical duration of connection of UE 103 to base station 207-2 and/or other base stations 207, or other suitable factors.

In some embodiments, HMHU Controller 101 may receive demand information from, and/or may derive demand information based on information received from, one or more elements of the wireless network. For example, a UE information repository (e.g., a Unified Data Management function (“UDM”), a Unified Data Repository (“UDR”), etc.) may maintain information indicating QoS parameters, SLAs, network slices, etc. associated with UE 103. In some embodiments, HMHU Controller 101 may receive such information via a NEF, a SCEF, or some other suitable secure interface with the wireless network.

HMHU Controller 101 may “prepare” base station 207-2 for UEs 103 entry to cell 209-2 by providing some or all of the information to base station 207-2. That is, base station 207-2 may be made “aware” that an HMHU UE (e.g., UE 103) is entering cell 209-2 implemented by base station 207-2. Base station 207-2 may further be made “aware” of the expected demand of UE 103, a time at which UE 103 is expected to enter cell 209-2, as well as the expected duration that UE 103 is expected to be connected to base station 207-2 (e.g., the expected duration of UE 103 within cell 209-2). Base station 207-2 may, based on the preparation, perform configuration modifications or other operations in order to accommodate the demand of UE 103 for the duration that UE 103 is connected to base station 207-2.

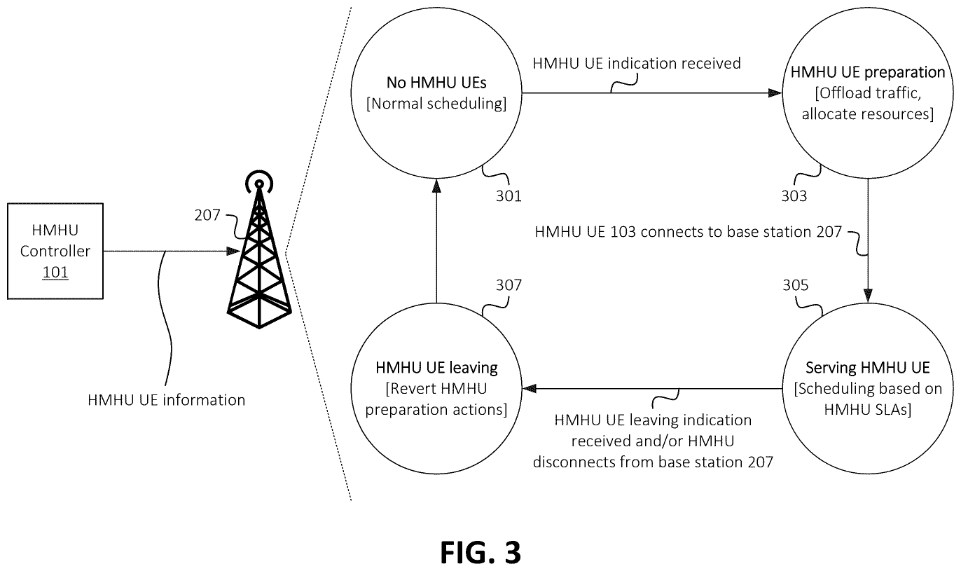

As shown in FIG. 3, for example, HMHU Controller 101 may output HMHU UE information to one or more base stations (e.g., a particular base station 207). The HMHU UE information may include, as discussed above, an indication that a particular HMHU UE (e.g., UE 103) is entering a coverage area of base station 207 and/or is otherwise expected to connect to base station 207, an indication of how long the particular HMHU UE is expected to remain connected to base station 207, a measure of demand associated with the HMHU UE while the HMHU UE is connected to base station 207, and so on. As another example, HMHU Controller 101 may, in some situations indicate that an HMHU UE, which is currently connected to base station 207, is expected to leave the coverage area of base station 207 at some point.

Base station 207 may, as shown, implement different scheduling states 301, 303, 305, and/or 307 based on indications (e.g., from HMHU Controller 101) of the entry or exit of an HMHU in the coverage area of base station 207. For example, base station 207 may be in a first scheduling state 301 when no HMHU UEs are connected to base station 207, and when no HMHU UEs are expected to be connected to base station 207. State 301 may include “normal” scheduling and/or resource allocations, in which base station 207 does not make any specific configuration modifications and/or does not perform any other operations to prepare for the connection of an HMHU UE to base station 207.

At some point, base station 207 may receive (e.g., from HMHU Controller 101) an HMHU UE indication, which may indicate that an HMHU UE (e.g., UE 103) is expected to connect to base station 207 at some future time (e.g., in 10 seconds, in 10 minutes, in one hour, etc.). Based on receiving the HMHU UE indication, base station 207 may enter state 303, in which base station 207 performs HMHU UE preparation operations. The HMHU UE preparation operations may be based on factors such as an expected demand of the HMHU UE, an expected duration of connection to base station 207, and/or other factors. In some embodiments, the HMHU UE preparation operations may additionally, or alternatively, be based on factors such as a current demand or load associated with base station 207 (e.g., a quantity of currently connected UEs 105, an amount of used and/or available wireless resources of base station 207, a measure of load or congestion of base station 207, etc.), and/or a measure of demand or load associated with base station 207 at the time that the HMHU UE is expected to connect to base station 207.

The HMHU UE preparation operations may include, for example, offloading traffic to other base stations 207 (e.g., “neighbor” base stations) in situations where base station 207 would be overloaded upon the connection of the HMHU UE to base station 207. As another example, base station 207 may reserve or allocate resources, such as radio resources (e.g., PRBs, symbols, etc.) or processing resources, for the HMHU UE. This reservation and/or allocation may include a “pre-allocation,” inasmuch as the allocation of such resources may be performed prior to the connection of the HMHU UE to base station 207 and/or prior to a request from the HMHU UE to base station 207 for such resources. In some embodiments, the HMHU UE preparation may include modifying priority levels associated with one or more UEs 105 that are connected to base station 207 (e.g., de-prioritizing one or more UEs 105, such that the HMHU UE may receive higher priority service or scheduling than the de-prioritized UEs 105).

After the HMHU UE ultimately connects to base station 207, base station 207 may enter state 305, in which base station 207 is serving the HMHU UE. In this state, base station 207 may perform scheduling and/or allocation operations in order to meet QoS parameters and/or SLAs of the HMHU UE, and/or to otherwise accommodate the demand of the HMHU UE, thus minimizing or eliminating the disruption of wireless services provided to the HMHU UE by the wireless network.

Subsequently, base station 207 may receive an indication that the HMHU UE is leaving the coverage area of base station 207 or is otherwise disconnecting from base station 207. For example, HMHU Controller 101 may indicate that the HMHU UE is disconnecting from base station 207, and/or may provide an expected time that the HMHU UE is expected to disconnect from base station 207. Additionally, or alternatively, base station 207 may identify a time at which the HMHU UE is expected to disconnect from base station 207 based on the time at which the HMHU UE connected to base station 207 as well as the indicated expected duration of the connection. Additionally, or alternatively, base station 207 may determine that the HMHU has already disconnected from base station 207.

Based on determining that the HMHU UE has disconnected from base station 207 (or will be disconnecting from base station 207), base station 207 may enter state 307, in which base station 207 reverts or begins to revert some or all of the HMHU preparation actions. For example, base station 207 may revert resource allocations to allocations that were previously configured before the HMHU UE connected to base station 207. Additionally, or alternatively, base station 207 may otherwise adjust the resource allocations to allocations that are no longer based on the demand of the HMHU UE. In this manner, base station 207 may continue to provide service to other UEs 105 “as normal,” inasmuch as the service does not need to account for the demand of an HMHU UE.

While FIG. 3 illustrates one example base station 207, similar concepts may apply to multiple base stations 207 of a RAN of a wireless network. For example, referring to the example of FIG. 2, UE 103 may be currently connected to base station 207-1, which may be in state 305 (e.g., serving UE 103). Additionally, HMHU Controller 101 may determine that UE 103 will be connecting to base station 207-2 relatively soon, and may notify base station 207-2 that an HMHU (i.e., UE 103) will be connecting to base station 207-2. Based on such notification, base station 207-2 may exit state 301 (e.g., a “normal scheduling” state) and may enter state 303 (e.g., an “HMHU UE preparation” state). Similarly, as UE 103 exits cell 209-1 and enters cell 209-2, base station 207-1 may exit state 305 and may enter state 307 to revert configuration modifications done in order to accommodate UE 103, and may subsequently return to state 301. On the other hand, base station 207-2 may exit state 303 and may enter state 305 in order to provide service to UE 103 in accordance with QoS parameters, SLAs, etc. associated with UE 103.

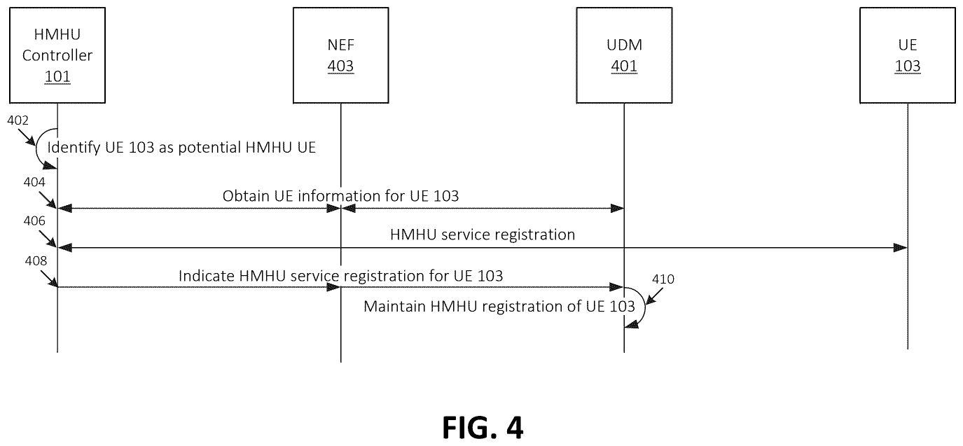

In some embodiments, HMHU Controller 101 may proactively identify potential HMHU UEs, and may facilitate a registration procedure with the wireless network in order to provide proactive scheduling and/or other configuration modifications in order to preserve QoS parameters or SLAs associated with the HMHUs. For example, as shown in FIG. 4, HMHU Controller 101 may identify (at 402) a particular UE 103 as a potential HMHU UE. As discussed above, HMHU Controller 101 may receive location information, usage information, and/or other suitable information associated with UE 103 in order to determine that UE 103 satisfies criteria associated with HMHU UEs. HMHU Controller 101 may communicate (at 404) with a user information repository of a wireless network with which UE 103 is registered, such as UDM 401, to determine whether UE 103 is already registered as an HMHU UE. For example, HMHU Controller 101 may output a request to UDM 401 via NEF 403 for UE information. In some embodiments, the UE information may include flags or indicators, such as “HMHU eligible” or “HMHU ineligible.” For example, an “HMHU ineligible” indicator may indicate that UE 103 is not permitted to be registered as an HMHU UE with the network. On the other hand, an “HMHU eligible” indicator may indicate that UE 103 is permitted to be registered as an HMHU UE, but is not currently registered as an HMHU UE. As another example, an “HMHU registered” indicator may indicate that UE 103 is already registered as an HMHU UE.

In this example, assume that the UE information for UE 103 indicates that UE 103 is eligible to be registered as an HMHU UE (and/or that UE 103 is not ineligible to be registered as an HMHU UE). In some embodiments, the UE information may include communication information via which HMHU Controller 101 may communicate with UE 103, such as a Mobile Directory Number (“MDN”), an Internet Protocol (“IP”) address, and/or other suitable information.

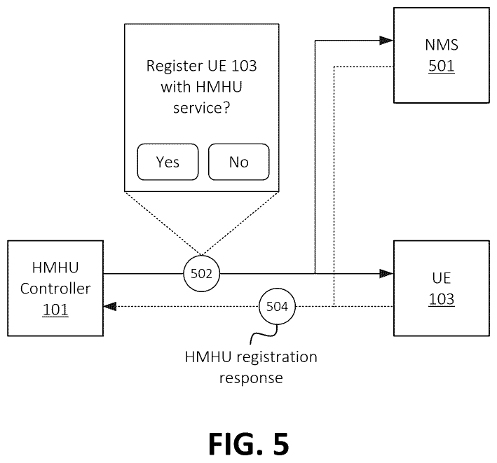

HMHU Controller 101 may communicate (at 406) with UE 103 to indicate eligibility for HMHU UE registration. For example, as shown in FIG. 5, HMHU Controller 101 may output (at 502) a prompt, notification, or other indication to UE 103, which may include an option to register UE 103 with an HMHU service (e.g., in which UE 103 is registered with the network as an HMHU UE). Additionally, or alternatively, HMHU Controller 101 may output the prompt or notification to Network Management System (“NMS”) 501, which may be associated with an administrator or operator (e.g., a mobile network operator (“MNO”)) of a wireless network with which UE 103 is registered. In this manner, users who may be unaware of the option for the HMHU service may be proactively alerted that certain UEs, such as UE 103, may receive better performance and/or reliability via the HMHU UE scheduling techniques described herein. Additionally, the wireless network may have the opportunity to offer the HMHU UE scheduling as a service, thereby enhancing the service offerings of the wireless network.

UE 103 and/or NMS 501 may provide (at 504) an HMHU registration response, such as indicating that UE 103 should (or should not be) registered as an HMHU UE. Returning to FIG. 4, and assuming that the response indicates that UE 103 should be registered as an HMHU UE, HMHU Controller 101 and/or some other suitable device or system (e.g., NMS 501) may indicate (at 408) to UDM 401 that UE 103 is associated with the HMHU service. UDM 401 may maintain (at 410) information indicating the HMHU registration of UE 103, which may be used by elements of the wireless network to ultimately provide the HMHU service to UE 103. In some embodiments, the HMHU registration information of UE 103 may include one or more QoS thresholds (e.g., minimum throughput and/or maximum latency), SLAs, network slices, or the like.

Returning to FIG. 3, base station 207 may receive UE information (e.g., from UDM 401) for one or more UEs that are expected to connect to or disconnect from base station 207. Base station 207 may accordingly “stitch” information from multiple sources to determine that certain states (e.g., an HMHU UE preparation state 303, an HMHU UE leaving state 307, etc.) should be entered. For example, HMHU Controller 101 and/or some other device or system may indicate that a particular UE 103 is expected to connect to base station 207 at a given time, and base station 207 may receive information from UDM 401 indicating that such UE 103 is an HMHU UE. Additionally, base station 207 may receive (e.g., from UDM 401) demand and/or QoS information, such as one or more QoS parameters, SLAs, network slices, etc. associated with UE 103 (e.g., based on the registration of UE 103 as an HMHU). Based on the information from these different sources, base station 207 may determine that base station 207 should enter HMHU UE preparation state 303 at a time that is based on the expected time of connection of UE 103 to base station 207.

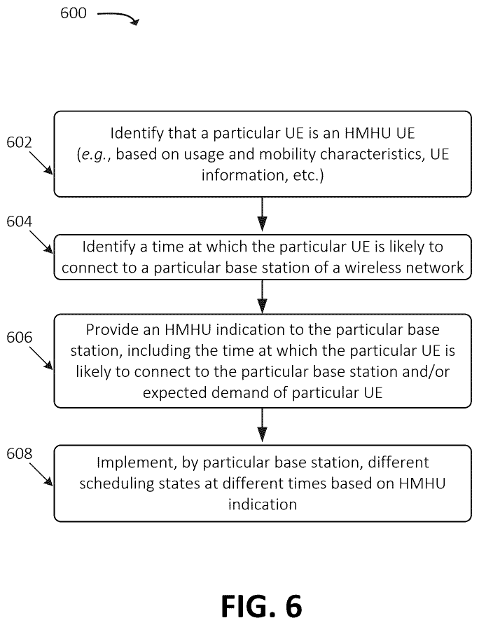

FIG. 6 illustrates an example process 600 for providing a high-mobility/high-usage service in a wireless network, in accordance with some embodiments. In some embodiments, some or all of process 600 may be performed by HMHU Controller 101.

As shown, process 600 may include identifying (at 602) that a particular UE is an HMHU UE. As noted above, the determination may be made based on usage and mobility characteristics of the particular UE, UE information associated with the particular UE (e.g., a network-provided UE profile), and/or other information. For example, as discussed above, HMHU Controller 101 may receive and/or monitor UE usage and/or location information associated with UE 103, and may determine based on the UE usage and/or location information that usage and mobility characteristics of the UE meet characteristics that are indicative of an HMHU UE. For example, HMHU Controller 101 may determine that one or more measures of UE usage satisfy one or more usage thresholds (e.g., at least a threshold quantity of PDU sessions, at least a threshold measure of throughput, etc.), and that one or more measures associated with UE location information satisfy one or more mobility thresholds (e.g., at least a threshold speed or velocity, lower than a threshold amount of time spent connected to one or more base stations of a wireless network, etc.). Additionally, or alternatively, HMHU Controller 101 may receive information from the wireless network (e.g., from a UE information repository such as a UDM, a UDR, or an HSS) indicating that UE 103 is an HMHU UE. In some embodiments, the UE information may include an indication that the UE is HMHU-eligible, and/or that the UE is not HMHU-ineligible.

Process 600 may further include identifying (at 604) a time at which the particular UE 103 is likely to connect to a particular base station 207 of the wireless network. For example, HMHU Controller 101 may determine that UE 103 is likely (e.g., beyond a threshold measure of likelihood or confidence) to connect base station 207 at a particular time based on a current location, trajectory, velocity, etc. of UE 103. Additionally, or alternatively, HMHU Controller 101 may determine that UE 103 is likely to connect to base station 207 based on historical location information, such as historical information indicating a repeating pattern (e.g., a daily connection of UE 103 to the particular base station 207 at a certain time of day), and/or other suitable information. In some embodiments, HMHU Controller 101 may utilize AI/ML techniques to determine or predict the time at which the particular UE 103 is likely to connect to the particular base station 207.

Process 600 may additionally include providing (at 606) an HMHU indication to the particular base station 207, including the time at which the particular UE 103 is likely to connect to the particular base station 207. In some embodiments, HMHU Controller 101 may additionally provide, to base station 207, a measure of traffic demand associated with UE 103, which may be based on historical usage information associated with UE 103 (e.g., indicating an amount of traffic sent and/or received by UE 103). Additionally, or alternatively, base station 207 may receive (e.g., from HMHU Controller 101, from UDM 401, and/or some other source) an indication of QoS parameters associated with UE 103 and/or associated with HMHU UEs, such as a minimum throughput, a maximum latency, or the like.

Process 600 may also include implementing (at 608), by the particular base station 207, different scheduling states at different times based on the received HMHU indication. For example, as discussed above with respect to FIG. 3, base station 207 may implement various states 301, 303, 305, and/or 307 based on the expected connection of UE 103 to base station 207, during the time that UE 103 is connected to base station 207, and after UE 103 has disconnected from base station 207 (or is expected to disconnect from base station 207). For example, as discussed above, base station 207 may enter an HMHU UE preparation state 303 prior to the expected to the indicated time at which UE 103 is likely to connect to base station 207, such as reallocating resources, offloading traffic, modifying priority levels, etc. Additionally, base station 207 may enter an HMHU UE leaving state 307 when determining that UE 103 has disconnected from base station 207, and/or when an expected duration of connection of UE 103 to base station 207 has elapsed. In this state, as discussed above, base station 207 may revert configuration modifications made to meet the traffic demand of UE 103, and may subsequently return to a “normal” scheduling state 301.

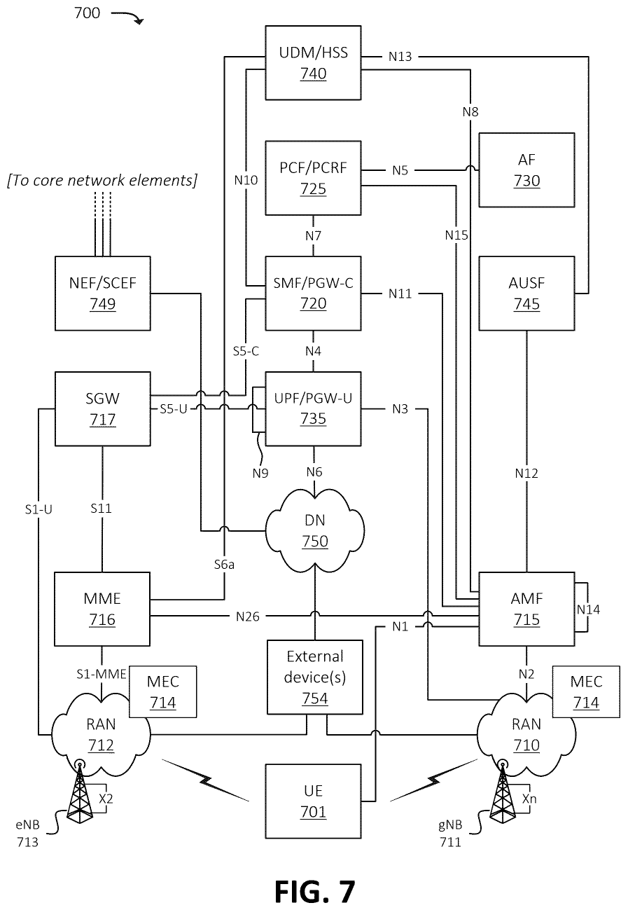

FIG. 7 illustrates an example environment 700, in which one or more embodiments may be implemented. In some embodiments, environment 700 may correspond to a 5G network, and/or may include elements of a 5G network. In some embodiments, environment 700 may correspond to a 5G Non-Standalone (“NSA”) architecture, in which a 5G RAT may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 701, RAN 710 (which may include one or more Next Generation Node Bs (“gNBs”) 711), RAN 712 (which may include one or more evolved Node Bs (“eNBs”) 713), and various network functions such as AMF 715, MME 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, UDM/Home Subscriber Server (“HSS”) 740, Authentication Server Function (“AUSF”) 745, and NEF/SCEF 749. Environment 700 may also include one or more networks, such as Data Network (“DN”) 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions (“VNFs”), Cloud-Native Network Functions (“CNFs”), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes® application programming interface (“API”) or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, and/or one or more other SBIs.

UE 701 may include a computation and communication device, such as a wireless mobile communication device that is capable of communicating with RAN 710, RAN 712, and/or DN 750. UE 701 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 701 may send traffic to and/or receive traffic (e.g., user plane traffic) from DN 750 via RAN 710, RAN 712, and/or UPF/PGW-U 735. UE 701 may be, may include, may implement, etc. UE 103 and/or 105.

RAN 710 may be, or may include, a 5G RAN that implements a 5G RAT and that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., user plane traffic such as voice call traffic, data traffic, messaging traffic, etc.) from UE 701 via the air interface, and may communicate the traffic to UPF/PGW-U 735 and/or one or more other devices or networks. Further, RAN 710 may receive signaling traffic, control plane traffic, etc. from UE 701 via the air interface, and may communicate such signaling traffic, control plane traffic, etc. to AMF 715 and/or one or more other devices or networks. Additionally, RAN 710 may receive traffic intended for UE 701 (e.g., from UPF/PGW-U 735, AMF 715, and/or one or more other devices or networks) and may communicate the traffic to UE 701 via the air interface. In some embodiments, base station 207 may be, may include, and/or may be implemented by one or more gNBs 711.

RAN 712 may be, or may include, an LTE RAN that implements an LTE RAT and that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 701 via the air interface, and may communicate the traffic to UPF/PGW-U 735 (e.g., via SGW 717) and/or one or more other devices or networks. Further, RAN 712 may receive signaling traffic, control plane traffic, etc. from UE 701 via the air interface, and may communicate such signaling traffic, control plane traffic, etc. to MME 716 and/or one or more other devices or networks. Additionally, RAN 712 may receive traffic intended for UE 701 (e.g., from UPF/PGW-U 735, MME 716, SGW 717, and/or one or more other devices or networks) and may communicate the traffic to UE 701 via the air interface. In some embodiments, base station 207 may be, may include, and/or may be implemented by one or more eNBs 713.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing (“MEC”) devices (referred to sometimes herein simply as a “MECs”) 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 701, via RAN 710 and/or 712. For example, RAN 710 and/or 712 may route some traffic from UE 701 (e.g., traffic associated with one or more particular services, applications, application types, etc.) to a respective MEC 714 instead of to core network elements of 700 (e.g., UPF/PGW-U 735). MEC 714 may accordingly provide services to UE 701 by processing such traffic, performing one or more computations based on the received traffic, and providing traffic to UE 701 via RAN 710 and/or 712. MEC 714 may include, and/or may implement, some or all of the functionality described above with respect to UPF/PGW-U 735, AF 730, one or more application servers, and/or one or more other devices, systems, VNFs, CNFs, etc. In this manner, ultra-low latency services may be provided to UE 701, as traffic does not need to traverse links (e.g., backhaul links) between RAN 710 and/or 712 and the core network.

AMF 715 may include one or more devices, systems, VNFs, CNFs, etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple instances of UPF/PGW-U 735 may be deployed (e.g., in different geographical locations), and the delivery of content to UE 701 may be coordinated via the N9 interface (e.g., as denoted in FIG. 7 by the line marked “N9” originating and terminating at UPF/PGW-U 735). Similarly, UPF/PGW-U 735 may receive traffic from UE 701 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a UDR. AUSF 745 and/or UDM/HSS 740 may perform authentication, authorization, and/or accounting operations associated with one or more UEs 701 and/or one or more communication sessions associated with one or more UEs 701.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 701 may communicate.

External devices 754 may include one or more devices or systems that communicate with UE 701 via DN 750 and one or more elements of 700 (e.g., via UPF/PGW-U 735). In some embodiments, external devices 754 may include, may implement, and/or may otherwise be associated with HMHU Controller 101. External devices 754 may include, for example, one or more application servers, content provider systems, web servers, or the like. External devices 754 may, for example, implement “server-side” applications that communicate with “client-side” applications executed by UE 701. External devices 754 may provide services to UE 701 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy (“SEPP”), which may perform some or all of the functions discussed above. External device 754 may, in some situations, subscribe to particular types of requested information provided by the one or more core network elements, and the one or more core network elements may provide (e.g., “push”) the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, SLAs, etc. (e.g., maximum latency thresholds, minimum throughput thresholds, etc.) associated with the services.

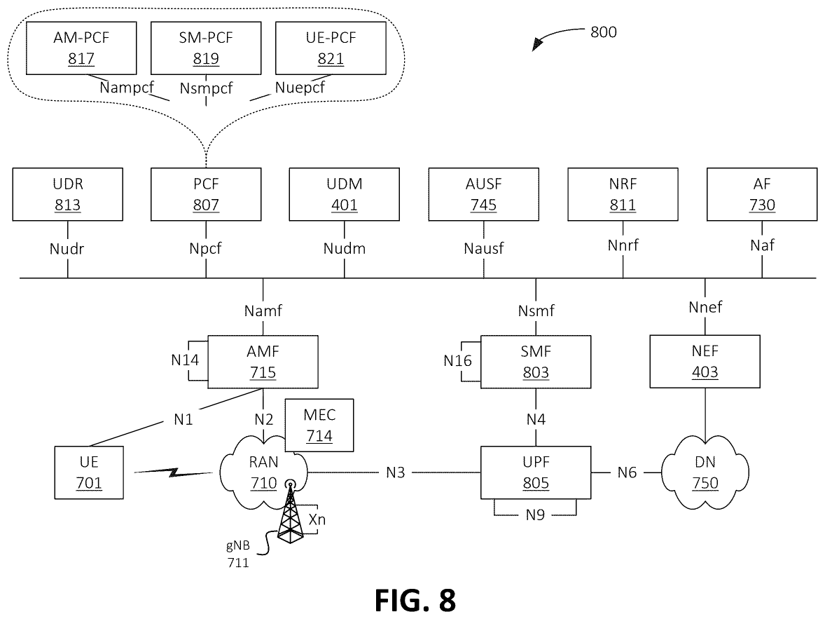

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 701, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 401, AUSF 745, Network Repository Function (“NRF”) 811, AF 730, UDR 813, and NEF 403. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 401, AUSF 745, etc.). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 401), an Npcf interface, an Nupf interface, an Nnef interface, an Nsmf interface, an Nnrf interface, an Nudr interface, an Naf interface, and/or one or more other SBIs.

UPF 805 may include one or more devices, systems, VNFs, CNFs, etc., that receive, route, process, and/or forward traffic (e.g., user plane traffic). As discussed above, UPF 805 may communicate with UE 701 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 701) from DN 750, and may forward the downlink user plane traffic toward UE 701 (e.g., via RAN 710). In some embodiments, multiple UPFs 805 may be deployed (e.g., in different geographical locations), and the delivery of content to UE 701 may be coordinated via the N9 interface. Similarly, UPF 805 may receive uplink traffic from UE 701 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 701 that communicate via the 5GC and/or RAN 710. PCF 807 may receive information regarding policies and/or subscriptions from one or more sources, such as subscriber databases (e.g., UDM 401, UDR 813, etc.), and/or from one or more users such as, for example, an administrator associated with PCF 807. In some embodiments, the functionality of PCF 807 may be split into multiple network functions or subsystems, such as access and mobility PCF (“AM-PCF”) 817, session management PCF (“SM-PCF”) 819, UE PCF (“UE-PCF”) 821, and so on. Such different “split” PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 401 and/or one or more other sources.

NEF 403 include one or more devices, systems, VNFs, CNFs, etc. that provide access to information, APIs, and/or other operations or mechanisms of the 5GC to devices or systems that are external to the 5GC. NEF 403 may maintain authorization and/or authentication information associated with such external devices or systems, such that NEF 403 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function (“CHF”) of the 5GC, and/or other suitable network function. NEF 403 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 403 may include, may implement, may be implemented by, and/or may otherwise be associated with a SCEF (e.g., NEF/SCEF 749); and so on.

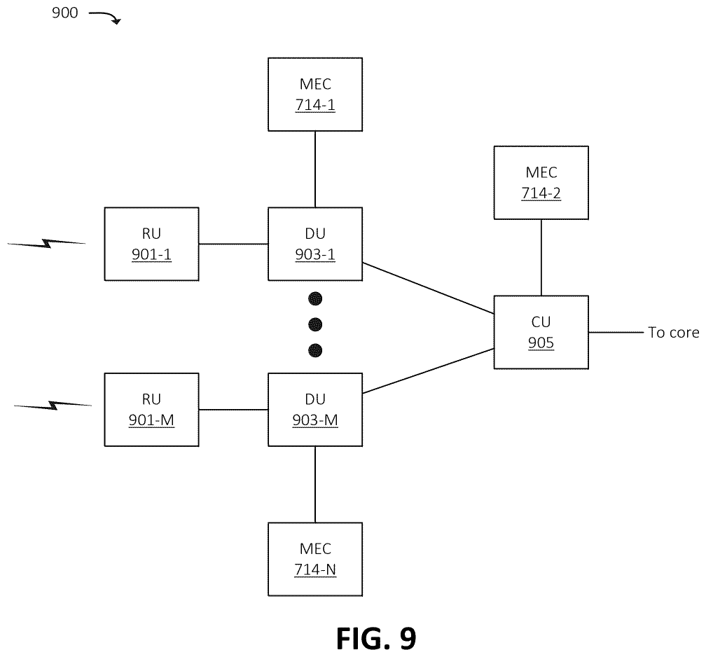

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-M (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 715 and/or UPF 805) and/or some other device or system such as MEC 714. In the uplink direction (e.g., for traffic from UEs 701 to a core network), CU 905 may aggregate traffic from DUs 903, and forward the aggregated traffic to the core network. In some embodiments, CU 905 may receive traffic according to a given protocol (e.g., Radio Link Control (“RLC”) traffic) from DUs 903, and may perform higher-layer processing (e.g., may aggregate/process RLC packets and generate Packet Data Convergence Protocol (“PDCP”) packets based on the RLC packets) on the traffic received from DUs 903.

CU 905 may receive downlink traffic (e.g., traffic from the core network, traffic from a given MEC 714, etc.) for a particular UE 701, and may determine which DU(s) 903 should receive the downlink traffic. DU 903 may include one or more devices that transmit traffic between a core network (e.g., via CU 905) and UE 701 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 701.

RU 901 may include hardware circuitry (e.g., one or more RF transceivers, antennas, radios, and/or other suitable hardware) to communicate wirelessly (e.g., via an RF interface) with one or more UEs 701, one or more other DUs 903 (e.g., via RUs 901 associated with DUs 903), and/or any other suitable type of device. In the uplink direction, RU 901 may receive traffic from UE 701 and/or another DU 903 via the RF interface and may provide the traffic to DU 903. In the downlink direction, RU 901 may receive traffic from DU 903, and may provide the traffic to UE 701 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 701, via a respective RU 901.

For example, DU 903-1 may route some traffic, from UE 701, to MEC 714-1 instead of to a core network via CU 905. MEC 714-1 may process the traffic, perform one or more computations based on the received traffic, and may provide traffic to UE 701 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 701, as traffic does not need to traverse DU 903, CU 905, links between DU 903 and CU 905, and an intervening backhaul network between RAN environment 900 and the core network.

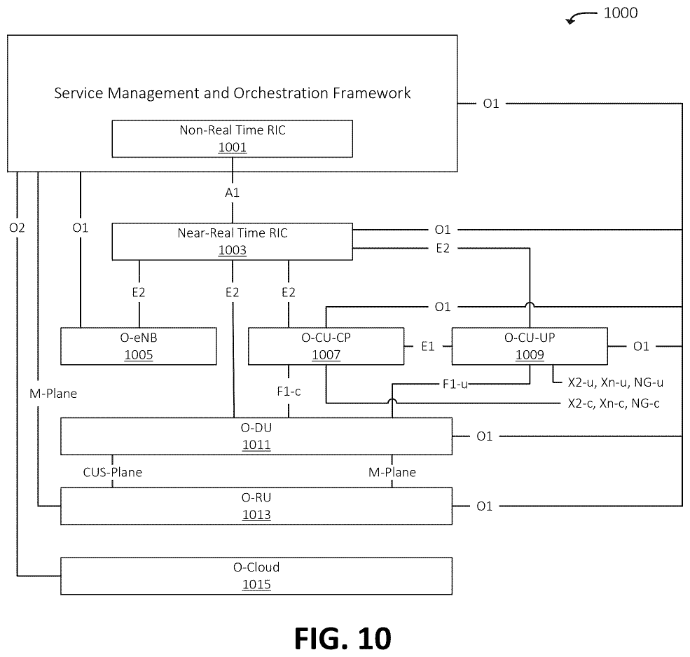

FIG. 10 illustrates an example O-RAN environment 1000, which may correspond to RAN 710, RAN 712, and/or RAN environment 900. For example, RAN 710, RAN 712, and/or RAN environment 900 may include one or more instances of O-RAN environment 1000, and/or one or more instances of O-RAN environment 1000 may implement RAN 710, RAN 712, RAN environment 900, and/or some portion thereof. As shown, O-RAN environment 1000 may include Non-Real Time Radio Intelligent Controller (“RIC”) 1001, Near-Real Time RIC 1003, O-eNB 1005, O-CU-Control Plane (“O-CU-CP”) 1007, O-CU-User Plane (“O-CU-UP”) 1009, O-DU 1011, O-RU 1013, and O-Cloud 1015. In some embodiments, O-RAN environment 1000 may include additional, fewer, different, and/or differently arranged components or interfaces.

In some embodiments, some or all of the elements of O-RAN environment 1000 may be implemented by one or more configurable or provisionable resources, such as virtual machines, cloud computing systems, physical servers, and/or other types of configurable or provisionable resources. In some embodiments, some or all of O-RAN environment 1000 may be implemented by, and/or communicatively coupled to, one or more MECs 714.

Non-Real Time RIC 1001 and Near-Real Time RIC 1003 may receive performance information (and/or other types of information) from one or more sources, and may configure other elements of O-RAN environment 1000 based on such performance or other information. For example, Near-Real Time RIC 1003 may receive performance information, via one or more E2 interfaces, from O-eNB 1005, O-CU-CP 1007, and/or O-CU-UP 1009, and may modify parameters associated with O-eNB 1005, O-CU-CP 1007, and/or O-CU-UP 1009 based on such performance information. Similarly, Non-Real Time RIC 1001 may receive performance information associated with O-eNB 1005, O-CU-CP 1007, O-CU-UP 1009, and/or one or more other elements of O-RAN environment 1000 and may utilize machine learning and/or other higher level computing or processing to determine modifications to the configuration of O-eNB 1005, O-CU-CP 1007, O-CU-UP 1009, and/or other elements of O-RAN environment 1000. In some embodiments, Non-Real Time RIC 1001 may generate machine learning models based on performance information associated with O-RAN environment 1000 or other sources, and may provide such models to Near-Real Time RIC 1003 for implementation.

In some embodiments, some or all of the operations described above with respect to HMHU Controller 101 may be performed by Non-Real Time RIC 1001 and Near-Real Time RIC 1003. Additionally, or alternatively, one or more of the operations described above with respect to Non-Real Time RIC 1001 and/or Near-Real Time RIC 1003 may be performed by HMHU Controller 101.

O-eNB 1005 may perform functions similar to those described above with respect to gNB 711 and/or eNB 713. For example, O-eNB 1005 may facilitate wireless communications between UE 701 and a core network. O-CU-CP 1007 may perform control plane signaling to coordinate the aggregation and/or distribution of traffic via one or more DUs 903, which may include and/or be implemented by one or more O-DUs 1011, and O-CU-UP 1009 may perform the aggregation and/or distribution of traffic via such DUs 903 (e.g., O-DUs 1011). O-DU 1011 may be communicatively coupled to one or more RUs 901, which may include and/or may be implemented by one or more O-RUs 1013. In some embodiments, O-Cloud 1015 may include or be implemented by one or more MECs 714, which may provide services, and may be communicatively coupled, to O-CU-CP 1007, O-CU-UP 1009, O-DU 1011, and/or O-RU 1013 (e.g., via an O1 and/or O2 interface).

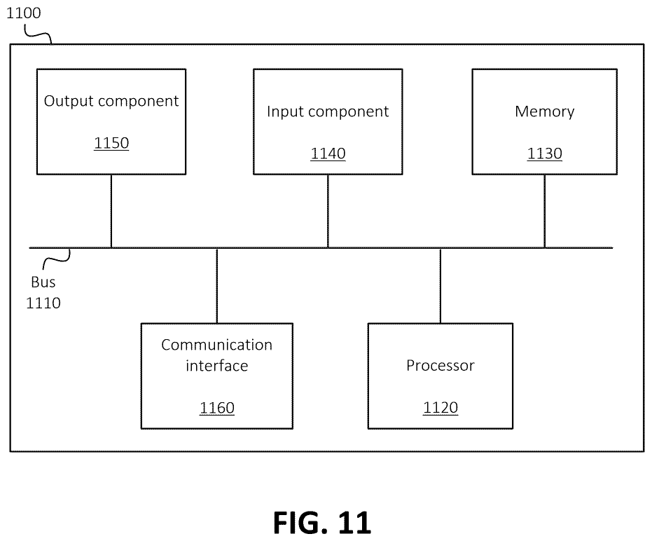

FIG. 11 illustrates example components of device 1100. One or more of the devices described above may include one or more devices 1100. Device 1100 may include bus 1110, processor 1120, memory 1130, input component 1140, output component 1150, and communication interface 1160. In another implementation, device 1100 may include additional, fewer, different, or differently arranged components.

Bus 1110 may include one or more communication paths that permit communication among the components of device 1100. Processor 1120 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1120 may be or may include one or more hardware processors. Memory 1130 may include any type of dynamic storage device that may store information and instructions for execution by processor 1120, and/or any type of non-volatile storage device that may store information for use by processor 1120.

Input component 1140 may include a mechanism that permits an operator to input information to device 1100 and/or other receives or detects input from a source external to input component 1140, such as a touchpad, a touchscreen, a keyboard, a keypad, a button, a switch, a microphone or other audio input component, etc. In some embodiments, input component 1140 may include, or may be communicatively coupled to, one or more sensors, such as a motion sensor (e.g., which may be or may include a gyroscope, accelerometer, or the like), a location sensor (e.g., a GPS-based location sensor or some other suitable type of location sensor or location determination component), a thermometer, a barometer, and/or some other type of sensor. Output component 1150 may include a mechanism that outputs information to the operator, such as a display, a speaker, one or more light emitting diodes (“LEDs”), etc.

Communication interface 1160 may include any transceiver-like mechanism that enables device 1100 to communicate with other devices and/or systems (e.g., via RAN 710, RAN 712, DN 750, etc.). For example, communication interface 1160 may include an Ethernet interface, an optical interface, a coaxial interface, or the like. Communication interface 1160 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1100 may include more than one communication interface 1160. For instance, device 1100 may include an optical interface, a wireless interface, an Ethernet interface, and/or one or more other interfaces.

Device 1100 may perform certain operations relating to one or more processes described above. Device 1100 may perform these operations in response to processor 1120 executing instructions, such as software instructions, processor-executable instructions, etc. stored in a computer-readable medium, such as memory 1130. A computer-readable medium may be defined as a non-transitory memory device. A memory device may include space within a single physical memory device or spread across multiple physical memory devices. The instructions may be read into memory 1130 from another computer-readable medium or from another device. The instructions stored in memory 1130 may be processor-executable instructions that cause processor 1120 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
identify that a particular User Equipment (“UE”), out of a plurality of UEs associated with a wireless network, is a high-usage high-mobility (“HMHU”) UE, wherein identifying that the particular UE is a HMHU UE includes:
determining that the particular UE is associated with a particular set of usage characteristics, and
determining that the particular UE is associated with a particular set of mobility characteristics;
identify a particular time at which the particular UE is likely to connect to a particular base station, of a plurality of base stations of the wireless network; and
indicate, to the particular base station, the particular time at which the particular UE is likely to connect to the particular base station, wherein the particular base station performs a set of configuration modifications to meet traffic demands of the particular UE when the particular UE connects to the particular base station.

2. The device of claim 1, wherein the one or more processors are further configured to:
indicate a measure of demand associated with the particular UE, wherein the set of configuration modifications performed by the base station includes one or more configuration modifications that are based on the indicated measure of demand associated with the particular UE.

3. The device of claim 1, wherein the one or more processors are further configured to:
determine historical location information associated with the particular UE, wherein identifying the particular time at which the particular UE is likely to connect to the particular base station is based on the historical location information associated with the particular UE.

4. The device of claim 1, wherein the one or more processors are further configured to:
obtain UE information, associated with the particular UE, from a UE information repository of the wireless network, wherein the UE information indicates at least one of:
that the particular UE is an HMHU UE,
that the particular UE is eligible to be an HMHU UE, or
that the particular UE is not ineligible to be an HMHU UE,
wherein determining that the particular UE is an HMHU UE is further based on the obtained UE information.

5. The device of claim 4, wherein the UE information repository of the wireless network includes at least one of:
a Unified Data Management function (“UDM”),
a Unified Data Repository (“UDR”), or
a Home Subscriber Server (“HSS”).

6. The device of claim 1, wherein the particular set of usage characteristics are based on historical usage information, associated with the particular UE, exceeding one or more usage thresholds.

7. The device of claim 1, wherein the particular set of mobility characteristics are based on historical location information, associated with the particular UE, wherein the historical location information indicates at least one of:
historical speeds or velocities of the particular UE, or
a duration of time that the particular UE was connected to one or more respective base stations of the wireless network.

8. A non-transitory computer-readable medium, storing a plurality of processor-executable instructions to:
identify that a particular User Equipment (“UE”), out of a plurality of UEs associated with a wireless network, is a high-usage high-mobility (“HMHU”) UE, wherein identifying that the particular UE is a HMHU UE includes:
determining that the particular UE is associated with a particular set of usage characteristics, and
determining that the particular UE is associated with a particular set of mobility characteristics;
identify a particular time at which the particular UE is likely to connect to a particular base station, of a plurality of base stations of the wireless network; and
indicate, to the particular base station, the particular time at which the particular UE is likely to connect to the particular base station, wherein the particular base station performs a set of configuration modifications to meet traffic demands of the particular UE when the particular UE connects to the particular base station.

9. The non-transitory computer-readable medium of claim 8, wherein the plurality of processor-executable instructions further include processor-executable instructions to:
indicate a measure of demand associated with the particular UE, wherein the set of configuration modifications performed by the base station includes one or more configuration modifications that are based on the indicated measure of demand associated with the particular UE.

10. The non-transitory computer-readable medium of claim 8, wherein the plurality of processor-executable instructions further include processor-executable instructions to:
determine historical location information associated with the particular UE, wherein identifying the particular time at which the particular UE is likely to connect to the particular base station is based on the historical location information associated with the particular UE.

11. The non-transitory computer-readable medium of claim 8, wherein the plurality of processor-executable instructions further include processor-executable instructions to:
obtain UE information, associated with the particular UE, from a UE information repository of the wireless network, wherein the UE information indicates at least one of:
that the particular UE is an HMHU UE,
that the particular UE is eligible to be an HMHU UE, or
that the particular UE is not ineligible to be an HMHU UE,
wherein determining that the particular UE is an HMHU UE is further based on the obtained UE information.

12. The non-transitory computer-readable medium of claim 11, wherein the UE information repository of the wireless network includes at least one of:
a Unified Data Management function (“UDM”),
a Unified Data Repository (“UDR”), or
a Home Subscriber Server (“HSS”).

13. The non-transitory computer-readable medium of claim 8, wherein the particular set of usage characteristics are based on historical usage information, associated with the particular UE, exceeding one or more usage thresholds.

14. The non-transitory computer-readable medium of claim 8, wherein the particular set of mobility characteristics are based on historical location information, associated with the particular UE, wherein the historical location information indicates at least one of:
historical speeds or velocities of the particular UE, or
a duration of time that the particular UE was connected to one or more respective base stations of the wireless network.

15. A method, comprising:
identifying that a particular User Equipment (“UE”), out of a plurality of UEs associated with a wireless network, is a high-usage high-mobility (“HMHU”) UE, wherein identifying that the particular UE is a HMHU UE includes:
determining that the particular UE is associated with a particular set of usage characteristics, and
determining that the particular UE is associated with a particular set of mobility characteristics;
identifying a particular time at which the particular UE is likely to connect to a particular base station, of a plurality of base stations of the wireless network; and
indicating, to the particular base station, the particular time at which the particular UE is likely to connect to the particular base station, wherein the particular base station performs a set of configuration modifications to meet traffic demands of the particular UE when the particular UE connects to the particular base station.

16. The method of claim 15, further comprising:
indicating a measure of demand associated with the particular UE, wherein the set of configuration modifications performed by the base station includes one or more configuration modifications that are based on the indicated measure of demand associated with the particular UE.

17. The method of claim 15, further comprising:
determining historical location information associated with the particular UE, wherein identifying the particular time at which the particular UE is likely to connect to the particular base station is based on the historical location information associated with the particular UE.

18. The method of claim 15, further comprising:
obtaining UE information, associated with the particular UE, from at least one of a Unified Data Management function (“UDM”), a Unified Data Repository (“UDR”), or a Home Subscriber Server (“HSS”), wherein the UE information indicates at least one of:
that the particular UE is an HMHU UE,
that the particular UE is eligible to be an HMHU UE, or
that the particular UE is not ineligible to be an HMHU UE,
wherein determining that the particular UE is an HMHU UE is further based on the obtained UE information.

19. The method of claim 15, wherein the particular set of usage characteristics are based on historical usage information, associated with the particular UE, exceeding one or more usage thresholds.

20. The method of claim 15, wherein the particular set of mobility characteristics are based on historical location information, associated with the particular UE, wherein the historical location information indicates at least one of:
historical speeds or velocities of the particular UE, or
a duration of time that the particular UE was connected to one or more respective base stations of the wireless network.
